(19) United States
(12) Patent Application Publication
(10) Pub. No.: US 2012/0217832 A1
(43) Pub. Date: Aug. 30, 2012

(54) HYDRODYNAMIC BEARING ASSEMBLY AND MOTOR INCLUDING THE SAME

(75) Inventors: Young Tae Kim, Seoul (KR); Won Ki Park, Seoul (KR)

(73) Assignee: SAMSUNG ELECTRO-MECHANICS CO., LTD., Suwon (KR)

(21) Appl. No.: 13/345,122

(22) Filed: Jan. 6, 2012

(30) Foreign Application Priority Data
Feb. 24, 2011 (KR) 10-2011-0016318

(51) Int. Cl. F16C 32/06; H02K 7/08

(52) U.S. Cl. 310/90; 384/114; 384/107

(57) ABSTRACT

Disclosed herein are a hydrodynamic bearing assembly and a motor including the same. The hydrodynamic bearing assembly includes: a sleeve supporting a shaft; and a sleeve housing combined with the sleeve to prevent the leakage of oil; and at least one stepped part formed on at least one of the sleeve and the sleeve housing in order to align an axis of the sleeve with an axis of the shaft and provide a bonding space with the sleeve therebetween.

### CROSS-REFERENCE TO RELATED APPLICATIONS

This application claims the priority of Korean Patent Application No. 10-2011-0016318 filed on Feb. 24, 2011, in the Korean Intellectual Property Office, the disclosure of which is incorporated herein by reference.

### BACKGROUND OF THE INVENTION

1. Field of the Invention

The present invention relates to a hydrodynamic bearing assembly and a motor including the same, more particular to a hydrodynamic bearing assembly and a motor including the same, in which the axial alignment of a shaft and a sleeve is promoted and an unmating force of a sleeve housing is improved.

2. Description of the Related Art

A hard disk drive (HDD), one of various types of information storage devices, reads data stored on a disk or writes data to a disk by using a read/write head.

This hard disk drive requires a disk driving device capable of driving the disk, and a small-sized motor is commonly used therefor.

A hydrodynamic bearing assembly is used in the small-sized motor, in which oil is interposed between a shaft, a rotating member of the hydrodynamic bearing assembly, and a sleeve, a fixed member of the hydrodynamic bearing assembly. The shaft is supported by fluid pressure generated in the oil.

As the sleeve in the small-sized motor, there may be provided a sinter sleeve or a process sleeve. The sinter sleeve containing a relatively large amount of oil is mainly used in order to enhance the price competitiveness of the motor.

However, when the sinter sleeve is used, since the sinter sleeve contains a relatively large amount of oil, a variation of an oil interface due to the thermal expansion of oil is increased, and a sleeve housing wrapping an outer diameter surface of the sleeve is required to prevent oil leakage.

This sleeve housing and sleeve are combined with each other by sliding or pressing the sleeve onto the sleeve housing, followed by bonding thereto. However, this process has a problem in that a bonding agent affects the assembling of a cover while flowing throughout an inside portion of the sleeve housing.

Furthermore, since the existing method of combining the sleeve and the sleeve housing does not sufficiently secure an unmating force of the sleeve housing, a problem may occur in which the sleeve and the sleeve housing are separated from one other due to an external impact, thus having a detrimental effect on the performance and lifespan of the motor.

Therefore, research into improving the method by which the sleeve and the sleeve housing are combined, in order to maximize the performance and lifespan of the motor, is urgently required.

### SUMMARY OF THE INVENTION

An aspect of the present invention provides a hydrodynamic bearing assembly and a motor including the same, in which an unmating force of a sleeve housing is improved and the axial alignment of a shaft and a sleeve is promoted.

According to an aspect of the present invention, there is provided a hydrodynamic bearing assembly, including: a sleeve supporting a shaft; a sleeve housing combined with the sleeve to prevent leakage of oil; and at least one stepped part formed on at least one of the sleeve and the sleeve housing in order to align an axis of the sleeve with an axis of the shaft and provide a bonding space with the sleeve therebetween.

The stepped part may be formed on an outer circumferential surface of the sleeve, and an outer diameter of the sleeve corresponding to an upper portion of the stepped part may be larger than an outer diameter of the sleeve corresponding to a lower portion of the stepped part.

The stepped part may be formed on an inner circumferential surface of the sleeve housing, and an inner diameter of the sleeve housing corresponding to an upper portion of the stepped part may be smaller than an inner diameter of the sleeve housing corresponding to a lower portion of the stepped part.

The stepped part may have an upper portion and a lower portion slopingly connected to each other.

An outer diameter of the sleeve corresponding to an upper portion of the stepped part may be larger than an inner diameter of the sleeve housing corresponding to the upper portion of the stepped part.

According to another aspect of the present invention, there is provided a hydrodynamic bearing assembly, including: a sleeve supporting a shaft; a sleeve housing combined with the sleeve to prevent leakage of oil; a thrust dynamic pressure part formed on at least one of an upper surface of the sleeve and an upper surface of the sleeve housing to provide thrust dynamic pressure; and at least one stepped part formed on at least one of an outer circumferential surface of the sleeve and an inner circumferential surface of the sleeve housing.

The stepped part may be formed on the outer circumferential surface of the sleeve, and an outer diameter of the sleeve corresponding to an upper portion of the stepped part may be larger than an outer diameter of the sleeve corresponding to a lower portion of the stepped part.

The stepped part may be formed on the inner circumferential surface of the sleeve housing, and an inner diameter of the sleeve housing corresponding to an upper portion of the stepped part may be smaller than an inner diameter of the sleeve housing corresponding to a lower portion of the stepped part.

The stepped part may have an upper portion and a lower portion slopingly connected to each other.

An outer diameter of the sleeve corresponding to an upper portion of the stepped part may be larger than an inner diameter of the sleeve housing corresponding to an upper portion of the stepped part.

According to another aspect of the present invention, there is provided a hydrodynamic bearing assembly, including: a sleeve supporting a shaft; a thrust plate combined with an upper portion of the shaft and disposed on an upper surface of the sleeve; a sleeve housing combined with the sleeve to prevent leakage of oil; and at least one stepped part formed on at least one of an outer circumferential surface of the sleeve and an inner circumferential surface of the sleeve housing.

The stepped part may be formed on the outer circumferential surface of the sleeve, and an outer diameter of the sleeve corresponding to an upper portion of the stepped part may be larger than an outer diameter of the sleeve corresponding to a lower portion of the stepped part.

The stepped part may be formed on the inner circumferential surface of the sleeve housing, and an inner diameter of the sleeve housing corresponding to an upper portion of the stepped part may be smaller than an inner diameter of the sleeve housing corresponding to a lower portion of the stepped part.

The stepped part may have an upper portion and a lower portion slopingly connected to each other.

An outer diameter of the sleeve corresponding to an upper portion of the stepped part may be larger than an inner diameter of the sleeve housing corresponding to the upper portion of the stepped part.

The sleeve housing may be extended inwardly in a radial direction such that the oil is sealed between the sleeve housing and an upper surface of the thrust plate.

According to another aspect of the present invention, there is provided a motor, including: the hydrodynamic bearing assembly as described above; a stator combined with an outside of the hydrodynamic bearing assembly, and having a core around which a coil for generating a rotation driving force is wound; and a rotor having a magnet installed on one surface thereof, the magnet facing the wound coil to be rotatable with respect to the stator.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view showing a motor including a hydrodynamic bearing assembly according to an exemplary embodiment of the present invention;

FIG. 2 is a cutaway perspective view showing a sleeve provided in a hydrodynamic bearing assembly according to an exemplary embodiment of the present invention;

FIG. 3 is a schematic perspective view showing a base member including a sleeve housing provided in a hydrodynamic bearing assembly according to an exemplary embodiment of the present invention;

FIG. 4 is a cross-sectional view showing a motor including a hydrodynamic bearing assembly according to another exemplary embodiment of the present invention;

FIG. 5 is a cutaway perspective view showing a sleeve provided in a hydrodynamic bearing assembly according to another exemplary embodiment of the present invention;

FIG. 6 is a cutaway perspective view showing a sleeve housing provided in a hydrodynamic bearing assembly according to another exemplary embodiment of the present invention;

FIG. 7 is a cross-sectional view showing a motor including a hydrodynamic bearing assembly according to another exemplary embodiment of the present invention; and

FIG. 8 is a cutaway perspective view showing a sleeve housing provided in a hydrodynamic bearing assembly according to another exemplary embodiment of the present invention.

### DETAILED DESCRIPTION OF THE PREFERRED EMBODIMENT

Exemplary embodiments of the present invention will now be described in detail with reference to the accompanying drawings. However, it should be noted that the spirit of the present invention is not limited to the embodiments set forth herein and those skilled in the art and understanding the present invention can easily accomplish retrogressive inventions or other embodiments included in the spirit of the present invention by the addition, modification, and removal of components within the same spirit, but those are construed as being included in the spirit of the present invention.

Further, like reference numerals will be used to designate like components having similar functions throughout the drawings within the scope of the present invention.

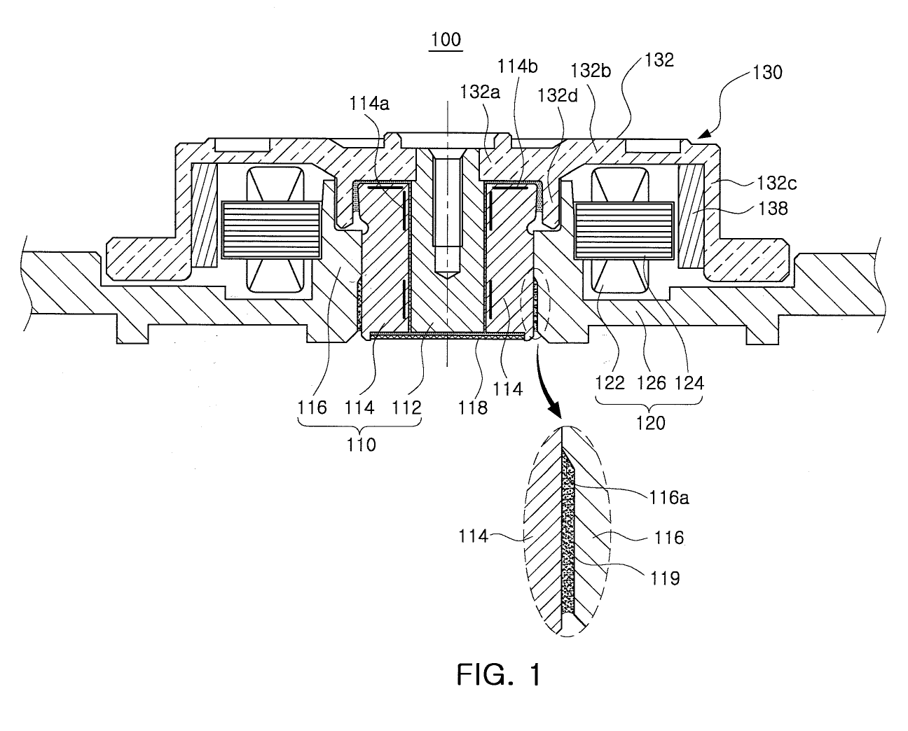

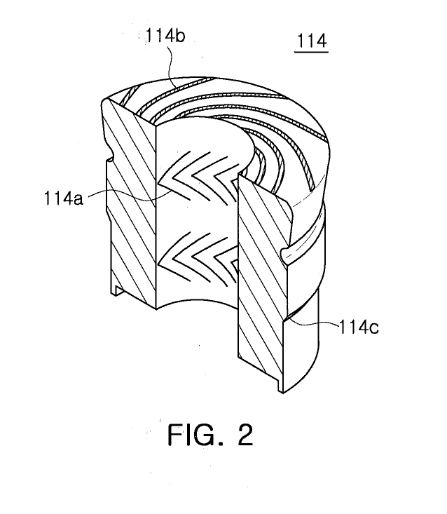

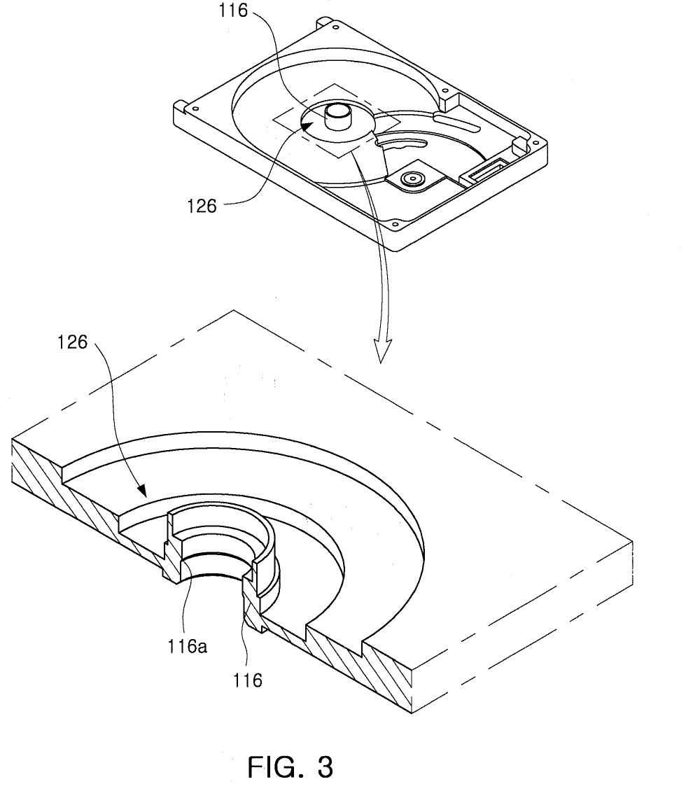

FIG. 1 is a cross-sectional view showing a motor including a hydrodynamic bearing assembly according to an exemplary embodiment of the present invention; FIG. 2 is a cutaway perspective view showing a sleeve provided in a hydrodynamic bearing assembly according to an exemplary embodiment of the present invention; and FIG. 3 is a schematic perspective view showing a base member including a sleeve housing provided in a hydrodynamic bearing assembly according to an exemplary embodiment of the present invention.

Referring to FIGS. 1 to 3, a motor 100 including a hydrodynamic bearing assembly 110 according to an exemplary embodiment of the present invention may include the hydrodynamic bearing assembly 110 including a sleeve 114 and a sleeve housing 116, a stator 120 including a core 124 around which a coil 122 is wound, and a rotor 130 including a magnet 138.

First, terms with regard to directions are defined. As viewed in FIGS. 1, 4, and 7, an axial direction refers to a vertical direction based on a shaft 112, and an outward radial direction and an inward radial direction refer to a direction towards an outer edge of a hub 132 based on the shaft 112 and a central direction of the shaft 112 based on the outer edge of the hub 132, respectively.

Hereafter, the above components will be described in detail.

The hydrodynamic bearing assembly 100 may include the shaft 112, the sleeve 114, and the sleeve housing 116.

The shaft 112, a rotating member, is combined with the hub 132 of the rotating rotor 130 to be interlockingly rotated with the hub 132, may be supported by the sleeve 114.

The sleeve 114 may be one constituent component of a stationary member which supports the shaft 112 so that an upper end of the rotating shaft 112 is protruded upwardly in the axial direction.

Herein, the sleeve 114 may be formed by forging Cu or Al, or sintering Cu—Fe based metal alloy powder and a Stainless Use Steel (SUS)-based powder. The shaft 112 may be inserted into the sleeve 114 such that the shaft 112 has a micro-gap with an axial hole of the sleeve 114 therebetween.

The micro-gap may be filled with oil. A radial dynamic pressure part 114a may be formed on at least one of an outer circumferential surface of the shaft 112 and an inner circumferential surface of the sleeve 114 to generate pressure causing the shaft 112 to be biased to one side during the rotation of the shaft 112. The rotation of the rotor 130 can be supported more smoothly by the radial dynamic pressure part 114a.

The radial dynamic pressure part 114a may have one of a herringbone shape, a spiral shape, and a helical shape, and its shape is not particularly limited so long as it can generate radial dynamic pressure.

The sleeve 114 may have a circulation hole (not shown) formed therein such that an upper part and a lower part of the sleeve 114 communicate with each other. Through the circulation hole, a pressure of the oil inside the motor 100 according to the present invention may be dispersed to maintain equilibrium, and air bubbles and the like existing inside the motor 100 may be eliminated through circulation.

A thrust dynamic pressure part 114b may be formed on at least one of an upper surface of the sleeve 114 and one surface of the hub 132 corresponding to the upper surface of the sleeve 114. The thrust dynamic pressure part 114b pumps the oil, which fills the space between the sleeve 114 and the hub 132, between the shaft 112 and the sleeve 114, to generate thrust dynamic pressure.

The thrust dynamic pressure part 114b may be formed on the upper surface of the sleeve 114 in FIG. 1, but the formation of the thrust dynamic pressure part 114b is not limited thereto.

Herein, the thrust dynamic pressure part 114b, as shown in FIG. 2, may have a spiral shape, but is not limited thereto. For example, the thrust dynamic pressure part 114b may have a herringbone shape or a helical shape.

An outer circumferential surface of an upper portion of the sleeve 114 may be formed to slope downwardly in the axial direction, thereby decreasing the outer diameter of the sleeve 114 and sealing the oil with a main wall part 132d therebetween to be described later.

Referring to FIG. 2, at least one stepped part 114c may be formed on the outer circumferential surface of the sleeve 114.

The size of the outer diameter of the sleeve 114 may vary by the stepped part 114c. More specifically, an outer diameter of the sleeve 114 corresponding to an upper portion of the stepped part 114c may be formed to be larger than an outer diameter of the sleeve 114 corresponding to a lower portion of the stepped part 114c.

Also, the upper portion and the lower portion of the stepped part 114c may be slopingly connected to each other. A plurality of stepped parts 114c may be provided.

In other words, when the plurality of stepped parts 114c are formed, the outer circumferential surface of the sleeve 114 may have a stairway shape in which the outer diameter of the sleeve 114 is decreased downwardly in the axial direction.

Herein, the stepped part 114c formed on the sleeve 114 is capable of improving the axial alignment of the shaft 112 and the sleeve 114, and increasing a bonding space between the sleeve 114 and the sleeve housing 116 to maximize the combining force therebetween. This will be described later in relation to the sleeve housing 116.

Herein, a cover plate 118 may be combined with the sleeve 114 at the lower portion of the sleeve 114 in the axial direction while the micro-gap is maintained, and the cover plate 118 receiving the oil may be inserted into the micro-gap.

The cover plate 118 and the sleeve 114 may receive the oil in the micro-gap therebetween, thus allowing the oil to perform a function as a bearing supporting a lower surface of the shaft 112.

The oil continuously fills the micro-gap between the shaft 112 and the sleeve 114, a micro-gap between the hub 132 and the sleeve 114, and a micro-gap between the cover plate 118, the shaft 112, and the sleeve 114, thereby forming a full-fill structure.

The sleeve housing 116 may be combined with the outer circumferential surface of the sleeve 114, and the sleeve 114 may be inserted into the inner circumferential surface of the sleeve housing 116 and combinedly bonded thereto.

Herein, the sleeve housing 116 may be a part of a base member 126 constituting the stator 120 to be later described, but will be described such that the sleeve housing 116 is regarded as a constituent component constituting the hydrodynamic bearing assembly 110, in order to describe the combination relationships between the sleeve 114 and the sleeve housing 116.

The sleeve housing 116 may be combined with the outer circumferential surface of the sleeve 114 containing the oil to prevent the leakage of the oil. The sleeve housing 116 may include at least one stepped part 116a positioned adjacently to the sleeve 114 to provide the bonding space therebetween.

The size of the inner diameter of the sleeve housing 116 may vary by the stepped part 116a. More specifically, the outer diameter of the sleeve housing 116 corresponding to an upper portion of the stepped part 116a may be formed to be smaller than an inner diameter of the sleeve housing 116 corresponding to a lower portion of the stepped part 116a.

In addition, the upper portion and the lower portion of the stepped part 116a may be slopingly connected to each other. The plurality of stepped parts 116a may be provided.

In other words, when the plurality of stepped parts 116a are formed, the inner circumferential surface of the sleeve housing 116 has a stairway shape in which the inner diameter of the sleeve housing 116 is increased downwardly in the axial direction.

Herein, with respect to the above-described stepped parts 114c and 116a, as shown in FIG. 1, the stepped parts 114c and 116a are not limited to those formed on the sleeve housing 116, and may be formed on at least one of the outer circumferential surface of the sleeve 114 and the inner circumferential surface of the sleeve housing 116.

The bonding space for combining the sleeve 114 and the sleeve housing 116 can be increased due to the stepped parts 114c and 116a.

The amount of bonding agent 119 for combining the sleeve 114 and the sleeve housing 116 may also be increased due to the bonding space, resulting in maximizing an unmating force by which the sleeve 114 and the sleeve housing 116 are not separated even by an external impact.

In addition, a space between the sleeve 114 and the sleeve housing 116 corresponding to upper portions of the stepped parts 114c and 116a may be formed to be very small. Therefore, when the sleeve 114 is inserted into the sleeve housing 116, the alignment between an axis of the shaft 112 and an axis of the sleeve 114 can be secured.

Therefore, since the degree of eccentricity is insignificant even though the axes of the shaft 112 and the sleeve are eccentric, the combining strength between the sleeve 114 and the sleeve housing 116 can be enhanced.

In addition, a space between the sleeve 114 and the sleeve housing 116 may be secured by the stepped parts 114c and 116a even during the combining process of the sleeve 114 and the sleeve housing 116, the sleeve 114 and the sleeve housing 116 are stably inserted into and combined with each other. A stable axial alignment between the shaft 112 and the sleeve 114 can be secured by a fine space between the sleeve 114 and the sleeve housing 116, which is formed at the upper portions of the stepped parts 114c and 116a, during the insertion.

The outer diameter of the sleeve 114 corresponding to the upper portions of the stepped parts 114c and 116a may be formed to be larger than the inner diameter of the sleeve housing 116 corresponding to the upper portions of the stepped parts 114c and 116a. In this case, the outer circumferential surface of the upper portion of the sleeve 114 may be pressed into and combined with the inner circumferential surface of the upper portion of the sleeve housing 116.

The stator 120 may include the core 124 around which the coil 122 is wound, and the base member 126, and may be a stationary member supporting the rotor 130 including the hub 132.

The base member 126 may beintegrated with the above-described sleeve housing 116. The base member 126 may be formed to extend outwardly in a radial direction of the sleeve housing 126 from an edge portion of the sleeve housing 126.

Herein, the core 124 may be fixed and disposed above the base member 126 including a printed circuit board (not shown) on which a pattern circuit is printed, that is, in the sleeve housing 116. A plurality of coil holes having a constant size may be formed in and penetrate through the upper surface of the base member 126 corresponding to the coil 122, such that the coil 122 is exposed downwardly. The coil 122 may be electrically connected to the printed circuit board (not shown) so that external power can be supplied to the coil 122.

The rotor 130 may include the hub 132 and the magnet 138, and may be a rotating structure rotatably provided with respect to the stator 120 including the base member 126.

In addition, a ring-shaped magnet 138 corresponding to the core 124 while having a predetermined space therebetween may be provided on an inner circumferential surface of the rotor 130.

More specifically, the hub 132 may include a first cylindrical wall part 132a fixed onto an upper end of the shaft 112, a circular plate part 134b extended outwardly in the radial direction from an edge portion of the first cylindrical wall part 132a, and a second cylindrical wall part 132c protruded downwardly in the axial direction from an outward edge portion in the radial direction of the circular plate 132b.

Herein, the magnet 138 may be combined with an inner circumferential surface of the second cylindrical wall part 132c, and a rotation driving force of the motor 100 according to the present invention may be obtained by interaction between the magnet 138 and the coil 122 winding around the core 124.

Also, oil may be sealed between the hub 132 and the outer surface of the upper portion of the sleeve 114. The hub 132 may include a main wall part 132d extended downwardly in the axial direction such that the oil is sealed.

In other words, the main wall part 132d may be protruded from one surface of the hub 132, a rotating member, towards the sleeve 114, the stationary member, to seal the oil therebetween, and may be extended along the outer surface of the sleeve 114, the stationary member, such that an oil interface can be formed between the main wall part 132d and the outer surface of the upper portion of the sleeve 114.

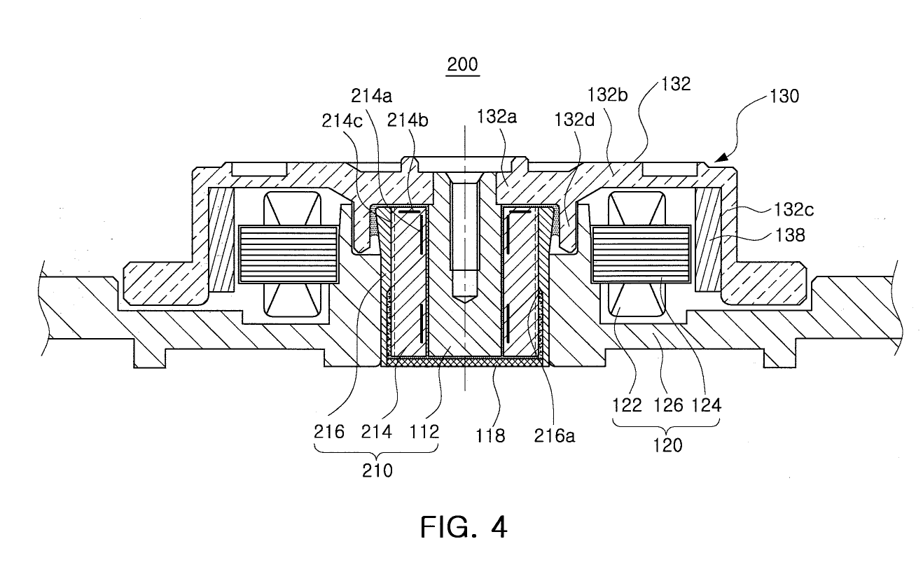

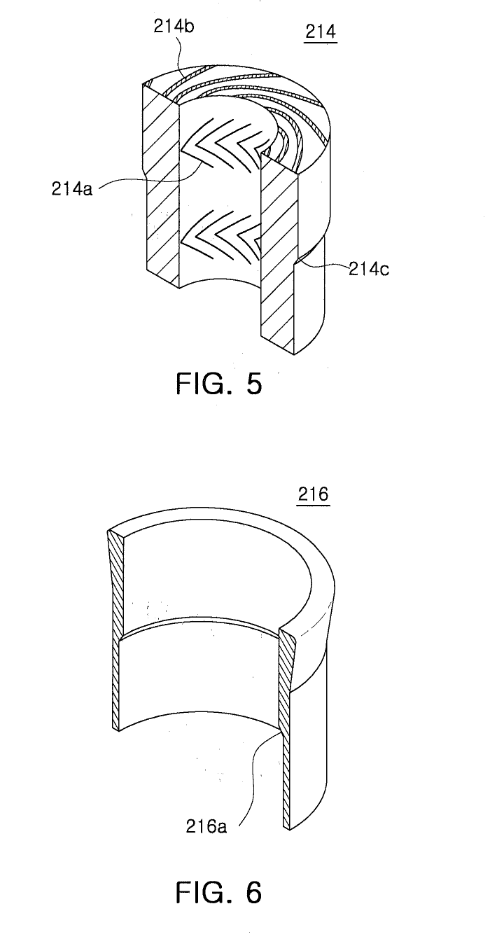

FIG. 4 is a cross-sectional view showing a motor including a hydrodynamic bearing assembly according to another exemplary embodiment of the present invention; FIG. 5 is a cutaway perspective view showing a sleeve provided in a hydrodynamic bearing assembly according to another exemplary embodiment of the present invention; and FIG. 6 is a cutaway perspective view showing a sleeve housing provided in a hydrodynamic bearing assembly according to another exemplary embodiment of the present invention.

Referring to FIGS. 4 to 6, since a motor 200 including a hydrodynamic bearing assembly 210 according to another exemplary embodiment of the present invention is the same as the motor 100 including the hydrodynamic bearing assembly 110 according to an exemplary embodiment of the present invention described above in terms of constitution and effect, except for a sleeve 214, a sleeve housing 216, and a base member 226, a detailed description of the same elements, except for the sleeve 214, the sleeve housing 216 and the base member 226, will be omitted.

The sleeve housing 216 provided in the hydrodynamic bearing assembly 210 according to another exemplary embodiment of the present invention may be an independent component from the base member 226, and combined with the outer circumferential surface of the sleeve 214.

The sleeve housing 216 may be combined with the outer circumferential surface of the sleeve 214 containing oil to prevent the leakage of the oil, and allow the oil to be sealed between the outer circumferential surface of the sleeve 214 and the main wall part 132d of the hub 132.

In other words, an oil interface may be formed between the outer circumferential surface of the upper portion of the sleeve housing 216 and the main wall part 132d, and the space between the above components may gradually widen downwardly in the axial direction in order to prevent the oil from being leaked to the outside at the time of driving the motor 200.

To enable this, the outer circumferential surface of the sleeve housing 216 corresponding to the main wall part 132d may be tapered in an outer diameter direction.

Also, as shown in FIGS. 4 and 5, a thrust dynamic pressure part 214b may be formed on the upper surface of the sleeve 214, but is not limited thereto. The thrust dynamic pressure part 214b may be formed on at least one of the upper surface of the sleeve 214, one surface of the hub 132 corresponding to the upper surface of the sleeve 214, and the upper surface of the sleeve housing 216.

Herein, the outer circumferential surface of the sleeve 214 may be formed in parallel with the shaft 112, and a circulation hole 214c may be formed such that the upper surface and the lower surface of the sleeve 214 communicate with each other.

The circulation hole 214c may allow the pressure of the oil inside the hydrodynamic bearing assembly 210 according to another exemplary embodiment of the present invention to be dispersed to thereby maintain equilibrium while causing bubbles and the like existing inside the hydrodynamic bearing assembly 210 to be moved and dissipated by circulation.

Also, as shown in FIG. 4, at least one stepped part 216a may be formed on the inner circumferential surface of the sleeve housing 216, but the present invention is not limited thereto. For example, as shown in FIG. 5, at least one stepped part 214c may be also formed on the outer circumferential surface of the sleeve 214.

In other words, at least one of the stepped parts 214c and 216a may be formed on at least one of the outer circumferential surface of the sleeve 124 and the inner circumferential surface of the sleeve housing 216. The constitution and effect of the stepped parts 214c and 216a are the same as those of the stepped parts 114c and 116a formed on the sleeve 114 and the sleeve housing 116 provided in the hydrodynamic bearing assembly 110 according to an exemplary embodiment of the present invention.

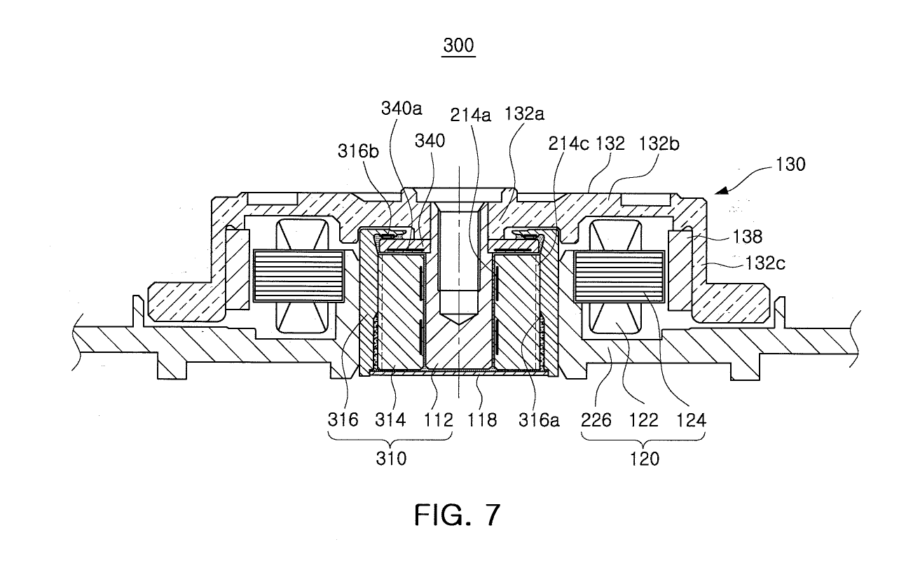

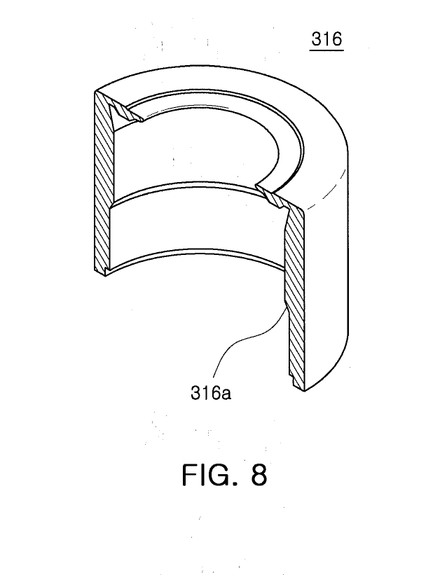

FIG. 7 is a schematic cross-sectional view showing a motor including a hydrodynamic bearing assembly according to another exemplary embodiment of the present invention; and FIG. 8 is a cut perspective view showing a sleeve housing provided in a hydrodynamic bearing assembly according to another exemplary embodiment of the present invention.

Referring to FIGS. 7 and 8, since a motor 300 including a hydrodynamic bearing assembly 310 according to another exemplary embodiment of the present invention is the same as the motor 200 including the hydrodynamic bearing assembly 210 according to another exemplary embodiment of the present invention described above in terms of constitution and effect, except for a thrust plate 340 and a sleeve housing 316, a detailed description of the same elements, except for the thrust plate 340 and the sleeve housing 316, will be omitted.

The thrust plate 340 provided in the hydrodynamic bearing assembly 310 according to another embodiment of the present invention may be positioned at an upper part of the sleeve 314 in the axial direction to be combined with the shaft 112.

The thrust plate 340 may have a hole corresponding to a section of the shaft 112 in the center thereof, and the shaft 112 may be inserted into this hole.

A thrust dynamic pressure part 340a generating thrust dynamic pressure may be formed on at least one of an upper surface or a lower surface of the thrust plate 340. The thrust dynamic pressure part 340a may have one of a herringbone shape, a spiral shape, or a helical shape.

The sleeve housing 316 may be combined with the outer circumferential surface of the sleeve 314 containing the oil to prevent the leakage of the oil. An edge portion of the sleeve housing 316 may be extended inwardly in the radial direction to seal the oil with the upper surface of the thrust plate 340 therebetween.

Therefore, the sleeve housing 316 may have a cap shape, and may include a protruding portion formed on one surface thereof corresponding to the upper surface of the thrust plate 340 such that the oil may be sealed between the sleeve housing 316 and the upper surface of the thrust plate 340.

This uses a capillary phenomenon and a surface tension of the oil in order to prevent the oil from leaking to the outside at the time of driving the motor.

A pumping groove 316b for pumping the oil between the shaft 112 and the sleeve 314 therethrough may be formed on one surface of the sleeve housing 316 corresponding to the upper surface of the thrust plate 340. The pumping groove 316b may prevent the oil from being leaked to the outside due to impact or vibration, and enable the oil to be pumped to an inside of the motor.

At least one of the stepped parts 214c and 316a may be formed on at least one of the outer circumferential surface of the sleeve 314 and the inner circumferential surface of the sleeve housing 316. The constitution and effect of the stepped parts 214c and 316a are the same as those of the stepped parts 214c and 216a formed on the sleeve 214 and the sleeve housing 216 provided in the hydrodynamic bearing assembly 210 according to another exemplary embodiment of the present invention.

According to the above exemplary embodiments of the present invention, bonding spaces for combining the sleeves 114, 214, and 314 and the sleeve housing 116, 216, and 316 can be increased, by forming the stepped parts 114c, 214c, 116a, 216a, and 316a at least one of the outer circumferential surfaces of the sleeves 114, 214, and 314 and the inner circumferential surfaces of the sleeve housings 116, 216, and 316 provided in the motors 100, 200, and 300.

Therefore, an unmating force can be enhanced by increasing the amount of bonding agent for combining the sleeves 114, 214, and 314 and the sleeve housings 116, 216, and 316.

In addition, the spaces between the sleeves 114, 214, and 314 and the sleeve housings 116, 216, and 316 corresponding to upper portions of the stepped parts 114c, 214c, 116a, 216a, and 316a can be formed to be very narrow, thereby securing the alignment of the axes of the shafts 112 and the axes of the sleeves 114, 214, and 314 when the sleeves 114, 214, and 314 are inserted into the housings 116, 216, and 316.

As set forth above, a hydrodynamic bearing assembly and a motor including the same according to exemplary embodiments of the invention are capable of improving the axial alignment of a shaft and a sleeve, and enhancing an unmating force of a sleeve housing to promote stability even in the case of an external impact.

While the present invention has been shown and described in connection with the exemplary embodiments, it will be apparent to those skilled in the art that modifications and variations can be made without departing from the spirit and scope of the invention as defined by the appended claims.

What is claimed is:

1. A hydrodynamic bearing assembly, comprising:
a sleeve supporting a shaft;
a sleeve housing combined with the sleeve to prevent leakage of oil; and
at least one stepped part formed on at least one of the sleeve and the sleeve housing in order to align an axis of the sleeve with an axis of the shaft and provide a bonding space with the sleeve therebetween.

2. The hydrodynamic bearing assembly of claim 1, wherein the stepped part is formed on an outer circumferential surface of the sleeve, and
an outer diameter of the sleeve corresponding to an upper portion of the stepped part is larger than an outer diameter of the sleeve corresponding to a lower portion of the stepped part.

3. The hydrodynamic bearing assembly of claim 1, wherein the stepped part is formed on an inner circumferential surface of the sleeve housing, and
an inner diameter of the sleeve housing corresponding to an upper portion of the stepped part is smaller than an inner diameter of the sleeve housing corresponding to a lower portion of the stepped part.

4. The hydrodynamic bearing assembly of claim 1, wherein the stepped part has an upper portion and a lower portion slopingly connected to each other.

5. The hydrodynamic bearing assembly of claim 1, wherein an outer diameter of, the sleeve corresponding to an upper portion of the stepped part is larger than an inner diameter of the sleeve housing corresponding to the upper portion of the stepped part.

6. A hydrodynamic bearing assembly, comprising:
a sleeve supporting a shaft;
a sleeve housing combined with the sleeve to prevent leakage of oil;
a thrust dynamic pressure part formed on at least one of an upper surface of the sleeve and an upper surface of the sleeve housing to provide thrust dynamic pressure; and
at least one stepped part formed on at least one of an outer circumferential surface of the sleeve and an inner circumferential surface of the sleeve housing.

7. The hydrodynamic bearing assembly of claim 6, wherein the stepped part is formed on the outer circumferential surface of the sleeve, and
an outer diameter of the sleeve corresponding to an upper portion of the stepped part is larger than an outer diameter of the sleeve corresponding to a lower portion of the stepped part.

8. The hydrodynamic bearing assembly of claim 6, wherein the stepped part is formed on the inner circumferential surface of the sleeve housing, and
an inner diameter of the sleeve housing corresponding to an upper portion of the stepped part is smaller than an inner diameter of the sleeve housing corresponding to a lower portion of the stepped part.

9. The hydrodynamic bearing assembly of claim 6, wherein the stepped part has an upper portion and a lower portion slopingly connected to each other.

10. The hydrodynamic bearing assembly of claim 6, wherein an outer diameter of the sleeve corresponding to an upper portion of the stepped part is larger than an inner diameter of the sleeve housing corresponding to an upper portion of the stepped part.

11. A hydrodynamic bearing assembly, comprising:
a sleeve supporting a shaft;
a thrust plate combined with an upper portion of the shaft and disposed on an upper surface of the sleeve;
a sleeve housing combined with the sleeve to prevent leakage of oil; and
at least one stepped part formed on at least one of an outer circumferential surface of the sleeve and an inner circumferential surface of the sleeve housing.

12. The hydrodynamic bearing assembly of claim 11, wherein the stepped part is formed on the outer circumferential surface of the sleeve, and
an outer diameter of the sleeve corresponding to an upper portion of the stepped part is larger than an outer diameter of the sleeve corresponding to a lower portion of the stepped part.

13. The hydrodynamic bearing assembly of claim 11, wherein the stepped part is formed on the inner circumferential surface of the sleeve housing, and
an inner diameter of the sleeve housing corresponding to an upper portion of the stepped part is smaller than an inner diameter of the sleeve housing corresponding to a lower portion of the stepped part.

14. The hydrodynamic bearing assembly of claim 11, wherein the stepped part has an upper portion and a lower portion slopingly connected to each other.

15. The hydrodynamic bearing assembly of claim 11, wherein an outer diameter of the sleeve corresponding to an upper portion of the stepped part is larger than an inner diameter of the sleeve housing corresponding to the upper portion of the stepped part.

16. The hydrodynamic bearing assembly of claim 11, wherein the sleeve housing is extended inwardly in a radial direction such that the oil is sealed between the sleeve housing and an upper surface of the thrust plate.

17. A motor, comprising:
the hydrodynamic bearing assembly according to claim 1;
a stator combined with an outside of the hydrodynamic bearing assembly, and having a core around which a coil for generating a rotation driving force is wound; and
a rotor having a magnet installed on one surface thereof, the magnet facing the wound coil to be rotatable with respect to the stator.
